(19) United States
(12) Patent Application Publication
(10) Pub. No.: US 2009/0150206 A1
(43) Pub. Date: Jun. 11, 2009

(54) NOTIFICATION SYSTEM AND METHOD

(75) Inventor: Tabatha L. Sikes, Broken Arrow, OK (US)

Correspondence Address: VERIZON;PATENT MANAGEMENT GROUP, 1320 North Court House Road, 9th Floor, ARLINGTON, VA, 22201-2909, US

(73) Assignee: MCI Communications Services, Ashburn, VA (US)

(21) Appl. No.: 11/952,490

(22) Filed: Dec. 7, 2007

(51) Int. Cl. G06F 17/30

(52) U.S. Cl. 705/8

(57) ABSTRACT

A system and method for generating and communicating notifications is provided. The system includes a notification generator in communication with a database. As information is uploaded into the database, the notification generator may populate the notifications with the information stored in the database before automatically transmitting the notifications. Accordingly, the method may include, but is not limited to, steps of receiving a service request, generating the order commitment notification based on the service request, and automatically transmitting the notification. The steps of the method may be performed by a computer, and specifically, a computer-readable medium may contain instructions for controlling the computer to perform the method steps.

### BACKGROUND INFORMATION

Improving customer satisfaction is an important aspect of any industry. However, customer satisfaction can quickly deteriorate because of a lack of communication between a business and its customers. This is especially true when businesses employ field account representatives to meet with customers, while others in the business perform services for the customer's benefit. As an example, in the telecommunications industry, field account representatives may help customers set up a new service plan or change an existing service plan. Field account representatives may also help customers update the infrastructure that provides service to the customer. The customer may require a faster internet connection. In such a situation the field account representative may suggest installing a new or additional local loop. Typically, a local service performer would perform the actual installation, but it would be the responsibility of the field account representative to schedule the installation and notify the customer and the local service performer of the installation date and time.

Several problems may arise with this arrangement. Continuing with the telecommunication example, the field account representative may forget to notify the customer of the date and time of the installation. By failing to receive the notification, the customer may not be available when the local service performer arrives to install the new local loop. Even if the customer is notified, an issue may arise where the local service performer must reschedule. In this instance, the local service performer must rely on the field account representative to notify the customer that the installation must be rescheduled. The same is true if the customer is unavailable at the scheduled time.

The notifications by the field account representative may be communicated to the customer and the local service performer via email or the telephone. When communication is via email, there is no central data store that stores all the notifications sent, The notification may be stored in the field account representative's email inbox, but the local service performer and the customer are unable to access the field account representative's email inbox to verify whether a notification was sent and the scheduled installation time. When communication is via telephone, it is possible that no written record of the communication exists.

Furthermore, the field account representative is responsible for notifying the customer that the service has been successfully performed. In cases where the service may be performed locally but tested remotely, the field account representative may not be notified when the remote testing indicates that the infrastructure was installed properly. Therefore, the field account representative is not able to notify the customer of the successful installation.

For at least these reasons, a system is needed that provides a central data store that stores notifications generated and communicated to the customer, the local service performers, and the technicians who test whether the installation/service provided was successful. Also, a system is needed that allows the customer to update the information in the data store, for instance, to change the installation date, and notifies others of the updated information.

### BRIEF DESCRIPTION OF THE DRAWINGS

FIG. 1 is a signal flow diagram of a system for generating and communicating notifications in accordance with an embodiment; and

FIG. 2 is a flowchart of a method for generating and communicating notifications in accordance with an embodiment,

### DETAILED DESCRIPTION

A system and method for generating and communicating notifications is provided. An exemplary system includes a notification generator in communication with at least one data store. The notification generator generates an order commitment notification and a ready notification that provide a customer with information about a service request. The service request may include installing a new service, updating an existing service, or updating an infrastructure used to provide the service. The notification generator may populate the order commitment notification with information stored in the data store before automatically transmitting the order commitment notification to a customer and a local service performer via the Internet or another communication network. The customer and/or the local service performer may upload updated information to the data store in response to the order commitment notification through a website or other computer application in communication with the data store, and the notification generator may generate an updated order commitment notification, which is then transmitted to the customer and the local service performer. The ready notification is transmitted to the customer and the local service performer if the service were successfully performed. An exemplary method could include, but is not limited to, receiving a service request, generating an order commitment notification based on the service request, and automatically transmitting the order commitment notification to the customer and the local service performer.

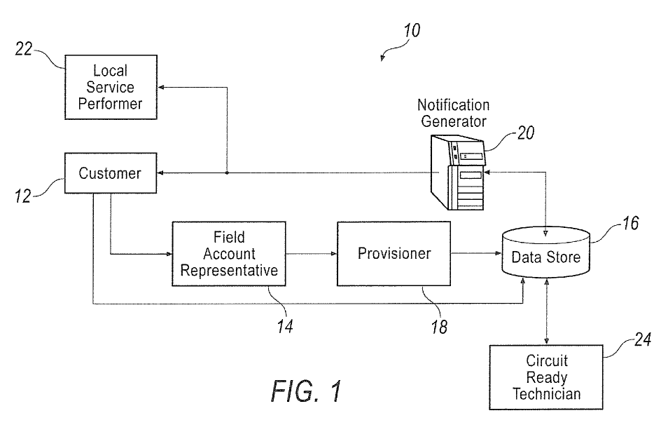

FIG. 1 is a signal flow diagram of an exemplary illustration of a system 10 for generating and communicating notifications. The system 10 may include a variety of hardware and/or software. For example, system 10 may include one or more computer servers associated with a regional data store management system (RDBMS) from which data may be extracted. However, system 10 may also represent other mechanisms for providing data, such as data stored in one or more files and obtained via file transfer protocol (FTP) or the like, data obtained from a computer-readable medium such as a disk or tape, or even manual entry of data, among other possible mechanisms. The precise number and type of computer servers included in the system 10 is not crucial. Further, it is not crucial that any of the information be stored in any particular data store. Thus, the system 10 may be configured to a variety of architectures.

In one exemplary approach, a customer 12 works with a field account representative 14 when service is requested. The customer 12 may communicate the service request to the field account representative 14 in person or through another form of communication. Other forms of communication may include an electronic communication such as email or an electronic message, or over the telephone. Then, the field account representative 14 may upload the service request and customer information directly to at least one data store 16. Data stores may be associated with various computing devices and may include a relational database management system (RDBMS). An RDBMS generally employs Structured Query Language (SQL) in addition to a language for creating, storing, editing, and executing stored procedures, such as the PL/SQL language mentioned above. However, it is to be understood that data stores associated with a computing device may be some other kind of database such as a hierarchical database, a set of files, and an application database in a proprietary format, etc. A data store often includes a computing device employing a computer operating system such as one of those mentioned above, and are accessed via a network in any one or more of a variety of manners, as is well known,

In another exemplary approach the field account representative may communicate the service request and customer information to another person or computer, such as a provisioner 18, who uploads the service request and customer information to the data store 16. In accordance with yet another example, the customer 12 may be in direct communication with the data store 16 and may upload service requests and customer information without the field account representative 14 or the provisioner 18. The service request and customer information is stored in the data store 16 in a medium that is easily accessible by a person or a computer program. For instance, the customer information may be stored in an electronic table. The data store 16 is in communication with a notification generator 20 that is configured to generate, for example, order commitment notifications and ready notifications, and transmit the order commitment notification and ready notification to the customer 12 and a local service performer 22. The order commitment notification may provide specific information to the customer 12 and to the local service provider 22 about the service to be performed. For instance, the order commitment notification may indicate to the customer 12 and the local service provider 22 the service to be preformed, as well as the date, time, and location of the service performance. The customer 12 and local service provider 22 may receive the order commitment notification in the form of an email or other electronic communication. The ready notification may provide other types of information to the customer 12 and the local service provider 22. For instance, the ready notification may indicate to the customer 12 and the local service provider 22 that the service was successfully performed. Like the order commitment notification, the ready notification may be transmitted to the customer 12 and the local service provider 22 via email or other electronic communication.

As previously stated, the notification generator 20 is configured to generate notifications such as the order commitment notification and the ready notification. The notification generator 20 may be an electronic device, such as a computer, that includes software that accesses the data store 16 and automatically populates fields of the order commitment notification or ready notification. In an exemplary illustration, the order commitment notification may have fields including, but not limited to, an order number, a customer name, the local service performer (discussed in greater detail below), a manager, an address of the customer, a field account representative, a field account manager, the service requested, the provisioner (or other person who entered the information into the data store 16), a firm order commitment date (i.e., the date on which the service will be performed), a firm order commitment time (i.e., the time at which the service will be performed), a local service performer order number, a recipient's email address, and a comment field. It is to be appreciated that the order commitment notification may have any number of fields, including additional or alternative fields than those listed. In an exemplary illustration, the ready notification may have fields including, but not limited to, an order number, customer name, local service performer, technician, technician manager, the address of the customer, the field account representative, the field account manager, the service requested, the firm order commitment date, the firm order commitment time, the ready date, the recipient's email address, and a comment field. It is to be appreciated that the ready notification may have any number of fields, including additional or alternative fields than those listed. It is to be appreciated that at least one of the order commitment notification and the ready notification may have at least one field that may be populated by the customer 12, the field account representative 14, the provisioner 18, or the local service performer 22.

In one example, a circuit ready technician 24 has a computer in communication with the data store 16. The circuit ready technician 24, as will be discussed in greater detail below, may test whether the service performed by the local service performer 22 was successful, and upload information to the data store 16 to generate the ready notification. In one exemplary approach, the data store 16 may automatically populate at least one field of the ready notification. However, it is to be appreciated that the ready notification may alternatively have at least one field that is populated by the circuit ready technician 24.

In addition to transmitting notifications to the customer 12, the local service performer 22, and the circuit ready technician 24, the notification generator 20 may also transmit the order commitment notification and the ready notification back to the data store 16. According to one possible approach, storing the order commitment notification and the ready notification in the data store 16 provides a central location for accessing a history of the services performed for the customer 12, as well as accessing customer information. In addition, the customer information provided in both the order commitment notification and the ready notification is consistent since the information comes from a single data store 16. However, it is to be appreciated that the information and notifications may be stored in multiple data stores that are in communication with one another.

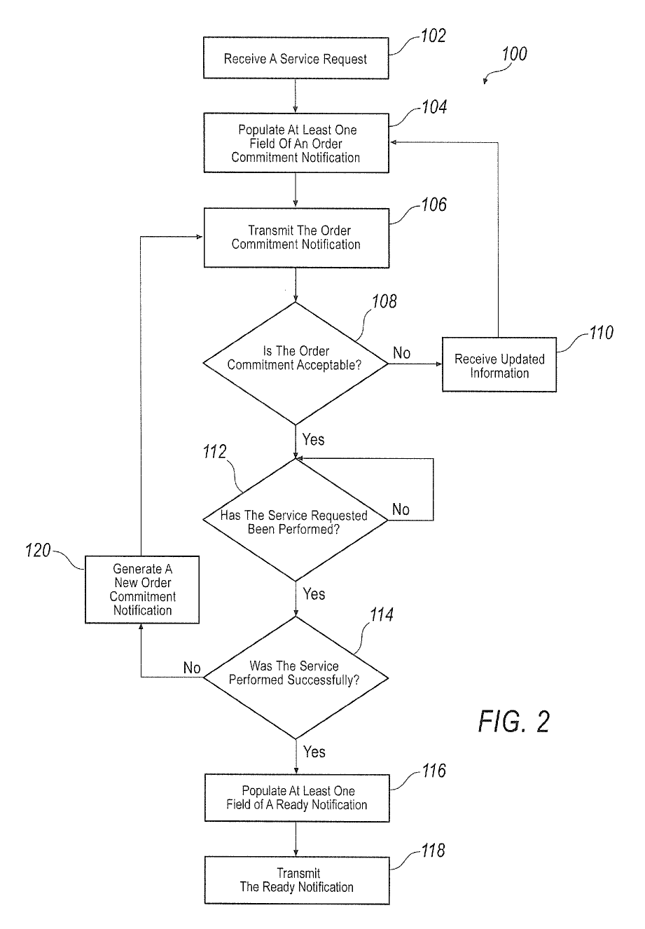

FIG. 2 is a flowchart of an exemplary method 100 for generating and communicating the order commitment notification and the ready notification. The method 100 includes a step 102 of receiving a service request. The service request may any type of service request. As previously mentioned, in one exemplary approach the service request may be to install a new service, update an existing service, or update an infrastructure used to provide the service. However, regardless of the service requested, it is to be appreciated that the method 100 may be applied to any request for a service.

The method 100 may farther include generating an order commitment notification based upon the service request. Generating the order commitment notification may include a step 104 of populating at least one field of the order commitment notification with customer information. The step 104 of populating at least one field of the order commitment notification with customer information may be performed automatically by the notification generator 20. Specifically, the notification generator 20 may electronically pull the customer information from the data store 16 and populate at least one field of the order commitment notification without human interaction. Customer information includes any information provided by the customer 12, including the customer's contact information and the service requested. It is to be appreciated that the customer information may include other information to fill in the fields of the order commitment notification previously described. Other fields not automatically populated may be populated by a person (such as the customer 12, the field account representative 14, or the provisioner 18) at a later time, or by the notification generator 20 once the customer information becomes known.

The method 100 may also include a step 106 of transmitting the order commitment notification to the customer 12 and the local service performer 22. The step 106 of transmitting the order commitment notification to the customer 12 and the local service performer 22 may be performed automatically by the notification generator 20. Specifically, the order commitment notification may be electronically transmitted to the customer 12 and the local service performer 22 once the customer information is provided without any further interaction from the customer 12, the field account representative 14, or the provisioner 18. Electronically communicating the order commitment notification may include transmitting the order commitment notification through, for instance, email or an electronic messenger program. However, it is to be appreciated that the order commitment notification may be transmitted through other forms of electronic communication.

In one exemplary approach, the local service performer 22 is the same entity as the company that provides the service. In another exemplary approach, the local service performer 22 is contracted by the company that provides the service, for instance, because the company that provides the service may not be located near the customer 12 or the location where the service is requested. In one example, the local service performer 22 may receive a temporary order commitment notification before the order commitment notification is sent to the customer 12. The date field and the time field in the temporary order commitment notification would either remain empty or be populated with a temporary date and time. In one example, the local service performer 22 may then populate or repopulate those fields with the actual date and time and retransmit the updated order commitment notification to the customer 12. In another example, the local service performer 22 may upload the updated date and time to the data store 16. The notification generator 20 pulls the updated date and time from the data store 16 and generates the updated order commitment notification. The notification generator 20 may then transmit the updated order commitment notification to the customer 12. If desired, the updated date and time may be retransmitted to the local service performer 22 as well.

Therefore, the method 100 may further include a step 108 of determining whether the information contained in the order commitment notification is acceptable. Specifically, after the customer 12 receives the order commitment notification, in one exemplary approach, the customer 12 may have the option of accepting the order commitment notification as it is. The customer 12 might do so if the information in the order commitment notification is accurate. The customer 12 may also have the option of rejecting the order commitment notification. In other words, the customer 12 may review the order commitment notification and determine that the information contained in the order commitment notification is not correct, or that the date and time of performing the service is unacceptable. In one exemplary approach, the order commitment notification may be transmitted in an email or other electronic communication having a link that will direct the customer 12 to a website or application where the customer 12 can amend the information in at least one of the fields. Specifically, the customer 12 may object to the date and time listed in those respective fields. For instance, the date and time may be when the customer 12 is unavailable. Therefore, the customer 12 may respond to the order commitment notification with an alternative date and time. Accordingly, the method 100 includes a step 110 of receiving updated information. The updated information may be transmitted to the data store 16. The method 100 may then execute the step 104 of populating at least one field of the order commitment notification with the updated information, and the step 106 of transmitting the order commitment notification to the customer 12 and the local service performer 22. As previously discussed, the step 104 of populating and the step 106 of transmitting may be automatically performed by the notification generator 20. In this example, the local service performer 22 may have an opportunity to approve of the updated information. For instance, if the customer 12 wishes to change the date and time of the service performance, then the local service performer 22 may be required to accept the updated information before the order commitment notification is generated. If acceptable to the local service performer 22, the alternative date and time are uploaded to the data store 16 and automatically populated into the respective fields. Similar to the previous example, the updated order commitment notification is then transmitted to the customer 12 and the local service performer 22. However, not all information may need approval by the local service performer 22. In one example, the customer 12 may wish to update its contact information. In this example, the updated contact information is transmitted to the data store 16 and the order commitment notification is repopulated with the new contact information without the prior approval of the local service performer 22. The notification generator 20 may then transmit the updated order commitment notification to the local service performer 22 and, if desired, to the customer 12 as well.

The method 100 may include a step 112 of determining whether the service requested has been performed. Once the service has been performed, the local service performer 22 may upload information to the data store 16 indicating that the service is complete. If the data store 16 fails to receive such information from the local service performer 22 within a predetermined amount of time from the date and time in the order commitment notification, the notification generator 20 may send a follow-up message to the local service performer 22 to determine whether the service was performed. In one example, the notification generator 20 may be programmed to send follow-up messages to the local service performer 22 if no updates have been received within 48 hours of the date and time the service was supposed to be performed. It is to be appreciated that the predetermined amount of time in the preceding example is merely exemplary and may be dependent upon any number of factors, including, but not limited to, the type of service requested, the distance between the local service performer 22 and the customer 12, and the workload of the local service performer 22.

The method 100 may further include a step 114 of determining whether the service has been performed successfully. In this step, at a predetermined time after the service requested is performed, the circuit ready technician 24 may perform a test to ensure that the service was performed correctly. In one example, the circuit ready technician 24 may perform the test remotely using a computer. Once the test is complete, the circuit ready technician 24 may upload the test results to the data store 16 electronically. If the test is successful, the notification generator 20 generates the ready notification to indicate that the service has been performed successfully, which may include a step 116 of automatically populating a field of the ready notification with the customer information stored in the data store 16, including any updated customer information previously provided by the customer 12. Then, the method 100 may include a step 118 of automatically transmitting the ready notification to the customer 12 and/or the local service performer 22. The ready notification may communicate to the customer 12 that the service has been performed successfully and that no further action is needed. If the circuit ready technician 24 finds that the service was not performed successfully, then the method 100 may include a step 120 of regenerating the order commitment notification, or generating a new order commitment notification. Specifically, in one exemplary approach, the regenerated or new order commitment notification is generated by the notification generator 20 and transmitted to the local service performer 22 and/or the customer 12. Again, the customer 12 and the local service performer 22 may agree on a date and time for the service to be performed.

The method steps described herein, may be generally tangibly embodied as one or more sets of computer-executable instructions stored on a computer-readable medium. Such computer readable-medium may be included in or associated with one or more computing devices, although such devices are not illustrated in FIG. 2. The method steps accordingly generally execute within one or more such computing devices. A computer-readable medium includes any medium that participates in providing data (e.g., instructions), which may be read by the computer. Such a medium may take many forms, including, but not limited to, non-volatile media, volatile media, and transmission media. Non-volatile media include, for example, optical or magnetic disks and other persistent memory. Volatile media include dynamic random access memory (DRAM), which typically constitutes a main memory. Transmission media include coaxial cables, copper wire and fiber optics, including the wires that comprise a system bus coupled to a processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium may include instructions for performing any of the steps previously recited. However, it is to be appreciated that the computer-readable medium may include instructions for performing steps other than those recited. It is to be further appreciated that some of steps may be performed by the computer, whereas other steps may be performed by a person or another computer.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain systems, and should in no way be construed so as to limit the claimed invention.

Accordingly, the above description is intended to be illustrative and not restrictive. Many systems and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future systems. In sum, it should be understood that the invention is capable of modification and variation and is limited only by the following claims.

All terms used in the claims are intended to be given their broadest reasonable constructions and their ordinary meanings unless an explicit indication to the contrary in made herein. In particular, use of the singular articles such as “a,” “the,” “said,” etc. should be read to recite or more of the indicated elements unless a claim recites explicitly to the contrary.

1. A method comprising:
receiving a service request;
generating an order commitment notification based on the service request; and
automatically transmitting the order commitment notification to a customer and a local service performer.

2. A method as set forth in claim 1, wherein generating the order commitment notification includes automatically populating at least one field of the order commitment notification with customer information.

3. A method as set forth in claim 1, further comprising:
receiving updated information; and
automatically populating at least one field of the order commitment notification with the updated information.

4. A method as set forth in claim 3, further comprising transmitting the updated order commitment notification to the customer and the local service performer.

5. A method as set forth in claim 1, further comprising generating a ready notification after the service requested has been performed.

6. A method as set forth in claim 5, wherein generating the ready notification includes automatically populating at least one field of the ready notification with customer information.

7. A method as set forth in claim 5, wherein generating the ready notification includes determining whether the service requested has been performed and whether the service requested was successful.

8. A method as set forth in claim 7, further comprising automatically transmitting the ready notification to the customer if the service requested was successfully performed.

9. A method as set forth in claim 1, wherein said method is performed by a computer executing instructions stored in a computer-readable medium.

10. A method comprising:
receiving a service request;
generating an order commitment notification based on the service request;
generating a ready notification after the service requested has been performed;
automatically transmitting the order commitment notification to a customer and a local service performer before the service has been performed; and
automatically transmitting the ready notification to the customer if the service requested was successfully performed.

11. A method as set forth in claim 10, wherein generating the order commitment notification and the ready notification includes automatically populating at least one field of the order commitment notification and the ready notification with customer information.

12. A method as set forth in claim 10, further comprising:
receiving updated information; and
automatically populating at least one field of the order commitment notification and the ready notification with the updated information.

13. A method as set forth in claim 10, further comprising storing the order commitment notification and the ready notification in a data store.

14. A system comprising:
at least one data store;
a notification generator in communication with said at least one data store; and
wherein said notification generator is configured to generate at least one notification and wherein said notification generator is configured to automatically populate at least one field of said at least one notification.

15. A system as set forth in claim 14, wherein said data store is configured to receive updated information.

16. A system as set forth in claim 15, wherein said notification generator is configured to automatically populate at least one field of said at least one notification with the updated information.

17. A system as set forth in claim 14, wherein said at least one notification is further defined as at least one of an order commitment notification and a ready notification.

18. A system as set forth in claim 17, wherein said at least one data store is configured to receive a service request and wherein said notification generator is configured to generate said order commitment notification based on the service request and said ready notification after the service request has been performed.

19. A system as set forth in claim 18, wherein said service request includes at least one of a request to install a new service, a request to update an existing service, and a request to update an infrastructure used to provide a service.

20. A system as set forth in claim 19, wherein said infrastructure includes a telecommunications network.

21. A system as set forth in claim 14, wherein said at least one notification is stored in said at least one data store.

22. A method as set forth in claim 1, wherein automatically transmitting the order commitment notification to a customer and a local service performer provides information about the service request to the customer and the local service performer before the service is performed.

23. A method as set forth in claim 14, wherein said notification generator automatically transmits said at least one notification to a customer and a local service provider before the service is performed to provide information about the service request to said customer and said local service provider.
